(19) United States
(12) Patent Application Publication
(10) Pub. No.: US 2005/0050665 A1
(43) Pub. Date: Mar. 10, 2005

(54) Roller Cover

(76) Inventor: Linda Mitchell, Nashville, TN (US)

Correspondence Address: CALFEE HALTER & GRISWOLD, LLP, 800 SUPERIOR AVENUE, SUITE 1400, CLEVELAND, OH, 44114, US

(21) Appl. No.: 10/876,185

(22) Filed: Jun. 24, 2004

Related U.S. Application Data
(63) Continuation-in-part of application No. 10/457,754, filed on Jun. 9, 2003.

(51) Int. Cl. B05C 17/02

(52) U.S. Cl. 15/230.11; 492/13; 492/19

(57) ABSTRACT

A roller cover for application of liquids or pastes such as wallcovering adhesive and stripper includes a foam substrate having an inner peripheral surface and an outer peripheral surface. The roller cover includes a bearing to which the inner peripheral surface of the foam substrate is secured, and a flocked covering on the outer peripheral surface of the foam substrate. The bearing has a central opening for receiving a shaft of a roller handle. The bearing includes a first portion to which the foam substrate is secured and a second portion for clamping the shaft of the roller handle when the bearing receives the shaft.

### RELATED APPLICATION

This application is a continuation in part of, and claims the benefit of the filing date of, U.S. application Ser. No. 10/457,754 filed Jun. 9, 2003, the entire disclosure of which is incorporated herein by reference.

### BACKGROUND OF THE INVENTION

1. Field of the Invention

The present invention relates generally to roller applicator devices. More particularly, the present invention teaches a generally cylindrical and sleeve shaped roller applicator and method of construction, and by which a quantity of precision cut synthetic fibers are applied by a suitable flocking process upon a foamed substrate material. The present invention is further an improvement over prior art foam and cloth applicators, in that it provides increased viscous fluid retention and application characteristics, particularly in use with thicker fluidic adhesives and such as are typically applied prior to the layering of a wallpaper or like wall covering material or gel removers which are applied to remove a previously applied wall covering.

2. Description of the Prior Art

Paint roller devices are fairly well known in the art. The most common type of roller is the foam roller having a specified length, diameter and foam nap. The dimensions of the foam nap typically range in the area of ⅜″.

It has been found that the typical foam roller, while generally being capable of adequately absorbing and reapplying volumes of paints, stains and varnishes, is poorly adapted for use in absorbing and reapplying volumes of viscous based wallpaper adhesive or gel removers, largely due to its fine and relatively small density foam material construction as well as the fact that only a thin layering of foam material is present on the roller. An additional problem with such foam material being utilized to absorb and reapply such adhesive further results from the greater density and weight associated with such fluid based adhesives and the fact that the conventional foam roller (typically thin layered) is very limited in the porous holding capability as a result of its given nap configuration. As such, the fluid adhesive tends to adhere only to the top surface of the foam roller and is substantially transferred onto the wall surface in the course of the initial swipe or stroke of the roller, thus greatly reducing the ability to thickly and evenly apply the adhesive or gel remover on the wall surface.

It has been found that rollers utilizing a given cloth nap design will in fact permit only a small amount of paste to absorb into the nap. However, much the same result as with the foam roller is achieved upon application and with substantially all the fluid adhesive/gel remover being transferred on the initial swipe across the wall surface and redistributed in succeeding strokes, thus resulting in generally thin and uneven applications. This further causes the applied adhesive to dry quickly, making the application of the wall covering (wallpaper, border, etc.) more difficult. It is additionally known to apply adhesives using a hand brush and, while being generally capable of absorbing and applying a minimal volume of fluid adhesive, the brush suffers from many of the shortcomings of foam and cloth nap rollers in that much of the retained adhesive is released/reapplied.

Additional examples of wall covering apparatuses are known in the prior art and a first example of which is referenced in U.S. Pat. No. 4,834,237, issued to Henke, et al. which teaches the provision of a wall covering kit having a tray, cover, and plurality of tool storage compartments. Among the tool implements used with the tray kit are a standard nap roller (with cage frame) and a substantially planar and rectangular shaped sponge (see illustrated in broken lines at 33 in Henke). Henke does not however teach or suggest the incorporation of a sponge mat or nap design into the roller implement, nor any inspiration for doing the same, including the desire to evenly and completely apply a fluid adhesive or the like.

Also, U.S. Pat. No. 5,837,084, issued to Barrs, teaches an improved method of making a single-cell structure including the formation of a double cell honeycomb fabric structure from a single continuous length of foldable material and which further removes parts of the cells defining a face of the double honeycomb structure in order to obtain a desired single-cell structure having folded outwardly extending pleats on one face and tabbed outwardly extending pleats on the other face. Barrs does not teach or suggest the application of such technology to the formation of an adhesive sponge roller with flock fiber nap or gel removal roller or like applicator.

### SUMMARY OF THE INVENTION

The present invention teaches a generally cylindrical and sleeve shaped roller applicator and method of construction, and by which a quantity of precision cut synthetic fibers are applied by a suitable flocking process upon a foamed substrate material of a sponge nap material. The fiber flocked roller applicator of the present invention is further an improvement over prior art paste applicators, such as again including paste brushes, foam paint rollers, and textile paint rollers, in that it provides for more consistent (accurate and thicker amount) and even distribution of the wallpaper paste material as well as the redistribution of the material, particularly in use with such as thicker fluidic adhesives and such as are typically applied prior to the layering of a wallpaper or like wall covering material and which are reapplied and redistributed in succeeding strokes. Also, a wallpaper gel remover is applied in the same fashion and in order to loosen up an existing wall covering.

In the preferred variant, the roller applicator includes a substantially sleeve shaped and conventional foam material having an outwardly facing surface and an inwardly facing surface dimensioned to be slidably engaged over a rotatable support associated with the application device, such as further may be a roller. In particular, and as is also known in the art, a hollow core element constructed of a moisture and solvent material may be employed as an intermediary between the inwardly facing surface of the body and the rotatably associated support of the applicator device, such including a plurality of spaced apart and parallel extending wire frame elements in one variant. A suitable applicator device may also consist of a plasticized and elongated tube inserted into the roller and which has a rotating clamp element in order to secure to an existing frame element.

Applied to the exterior or outwardly facing surface of the foams sleeve body is a plurality of precision cut synthetic fibers, such as including nylon, polyester, rayon or acrylic materials. The fibers are typically applied by a “flocking” process and by which they are adhered to a pre-applied adhesive coated upon the exterior surface of the foam sleeve. The flocking process may further include both mechanical processes in which the synthetic fibers are applied to the adhesively coated surface of the foam roller, as well as electrostatic processes by which the fibers are magnetically attracted to the desired coating surface through the creation of an electrical field.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a view of a substantially sleeve shaped and flocked roller according to a first preferred embodiment of the present invention;

FIG. 2 is a side view of a further variation of sleeve shaped and flocked roller exhibiting a different handle configuration and according to the present invention;

FIG. 3 is a first end view of a foam roller illustrating a plurality of flocked fibers applied thereupon and according to the present invention;

FIG. 4 is a second end view of a foam roller and illustrating a further plurality of flocked fibers applied thereupon according to the present invention;

FIG. 5 is an illustration of an electrostatic application process and by which the fibers are flocked upon the foam sleeves according to the present invention;

FIG. 6 is a perspective illustration of a foam roller and illustrating the pre-application of adhesive upon its exterior facing surface;

FIG. 7 is an illustration of a mechanical application process and by which the fibers are again applied upon the exterior facing surface of the foam sleeves;

FIG. 8 is an exploded perspective view of a roller that is a further embodiment of the invention;

FIG. 9 is an assembled view of the roller of FIG. 8; and

FIG. 10 is a view similar to FIG. 9 of a roller similar to the roller of FIG. 9.

### DETAILED DESCRIPTION OF THE PREFERRED EMBODIMENTS

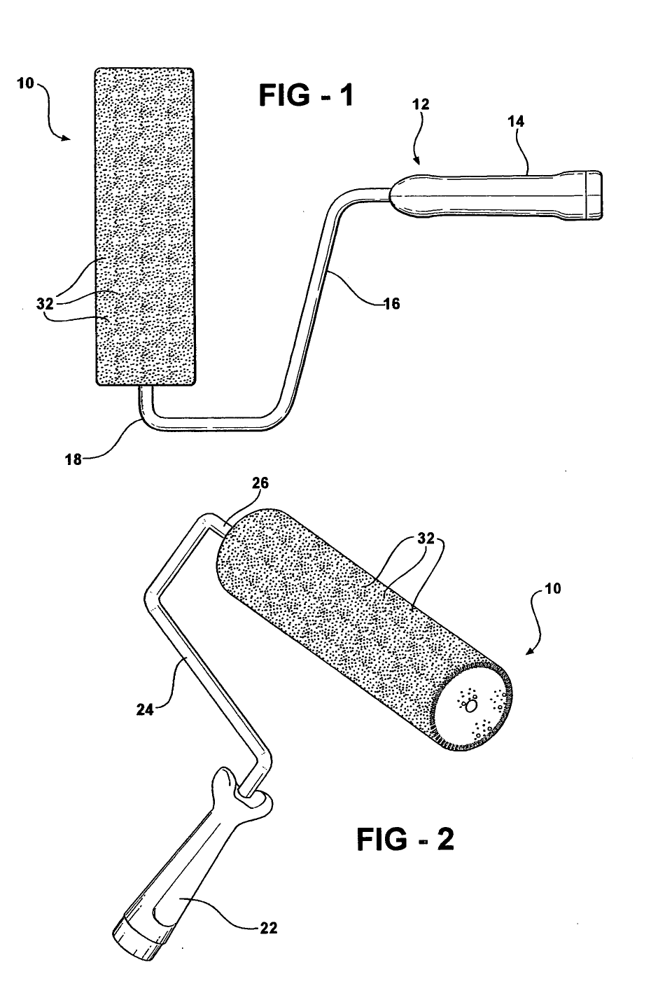

Referring now to FIG. 1, the substantially sleeve shaped and flocked roller is illustrated at 10 according to a first preferred embodiment of the present invention. As previously described, the present invention is an improvement over prior art foam and cloth nap roller' applicators, as well as hand-held brush applicators, in that the synthetic cut fibers applied to the roller provide appropriate flow of the fluid material applied, the foam pores providing increased viscous fluid retention and even application characteristics, particularly in use with thicker fluidic adhesives (as well as gel wallpaper removers) and such as are typically applied prior to the layering of a wallpaper or like wall covering material or reapplication/redistribution over succeeding strokes, as well as after a previously applied wall covering in the instance of a gel remover.

Referring again to FIG. 1, the roller 10 is again illustrated in combination with an applicator device, generally represented at 12, and for use in the application of the viscous fluid (not shown) onto a wall surface. The applicator device is by itself relatively known in the art and includes such features as a handle 14, an arcuately configured and extending neck 16 and support 18.

Referring to FIG. 1, opposite end 19 may be designed to cut into corners of a wall surface, as well as roll along an edge of a wall covering and in order to quickly coat the edges thereof.

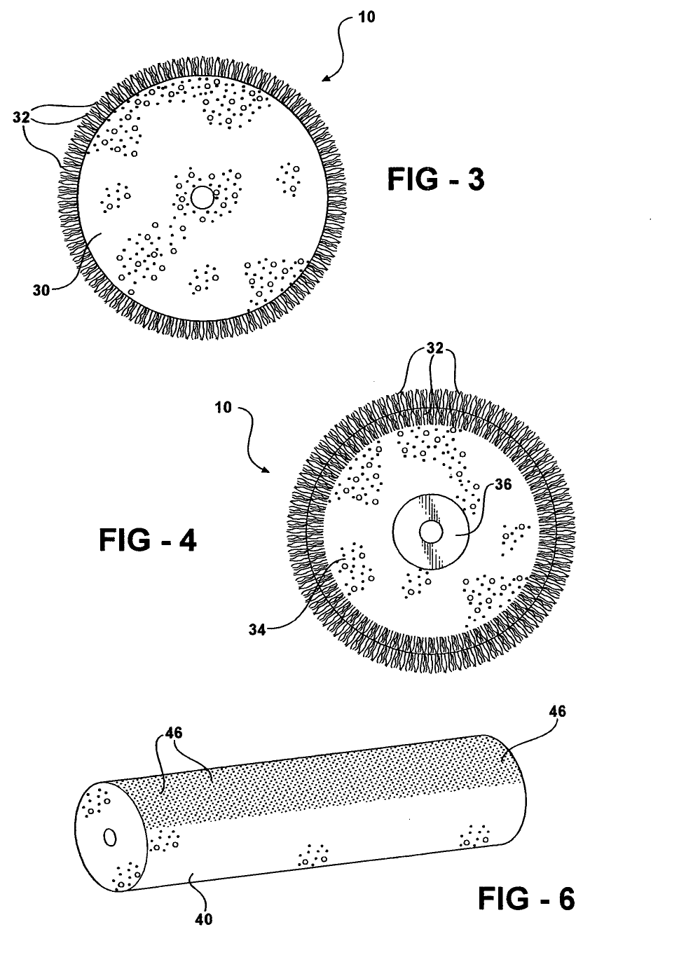

Referring again to the alternate configuration of FIG. 2, another variation of a rotatable support 20 is illustrated in use with the roller 10 and again includes a handle 22, arcuately configured and extending neck 24, and extending support 26. Although not further shown, in either FIGS. 1 and 2, the rotatable supports 18 and 26 may, as is conventionally known, further include a plurality (such as five) of spaced apart and parallel extending wire frame elements and over which the roller 10 is applied, typically in a friction fitting manner. Although not also shown, it is also understood that an elongated pole or other suitable attachment may be engaged (typically in threaded fashion) with a selected insertion end of the handle configurations and as is well known in the art. As has again been previously stated, the applicator device may also consist of a plasticized and elongated tube inserted into the roller and which has a rotating clamp element in order to secure to an existing frame element. Referring now to FIG. 3, an end view is illustrated of a foam roller 10, see in particular first circular end 30, and upon which a plurality of flocked fibers 32 are applied (according to either the mechanical or electrostatic methods to be subsequently described) and according to the present invention. The ability to apply a plurality of synthetic cut fibers, such as again including those drawn from such materials as nylon, polyester, acrylic and rayon, enables the flocked fibers 32 on the roller 10 to redistribute the desired fluidic material previously absorbed by the foam pores more evenly and to a greater degree.

Referring to FIG. 4, a second end view of the foam roller 10 is exhibited and which illustrates a further plurality of flocked fibers 32 applied thereupon. The end view of FIG. 4, illustrating a second circular end 34, also includes a narrowed central aperture which is defined by an annular core 36 and facilitates the insertion of a suitable and narrow rotatable support element. It has also been determined that the small diameter tube insert, for holding wire frame elements (not shown) allows for a desired increase in the thickness or depth of the foam versus standard 2 inch diameter cage frames. It has further been determined that a suitably constructed flock roller can hold a greater percentage of adhesive fluid or paste than that which is associated with conventional foam and textile rollers with a standard cage frame design or standard ½-¼″ nap or a standard PVC for cage frame rollers.

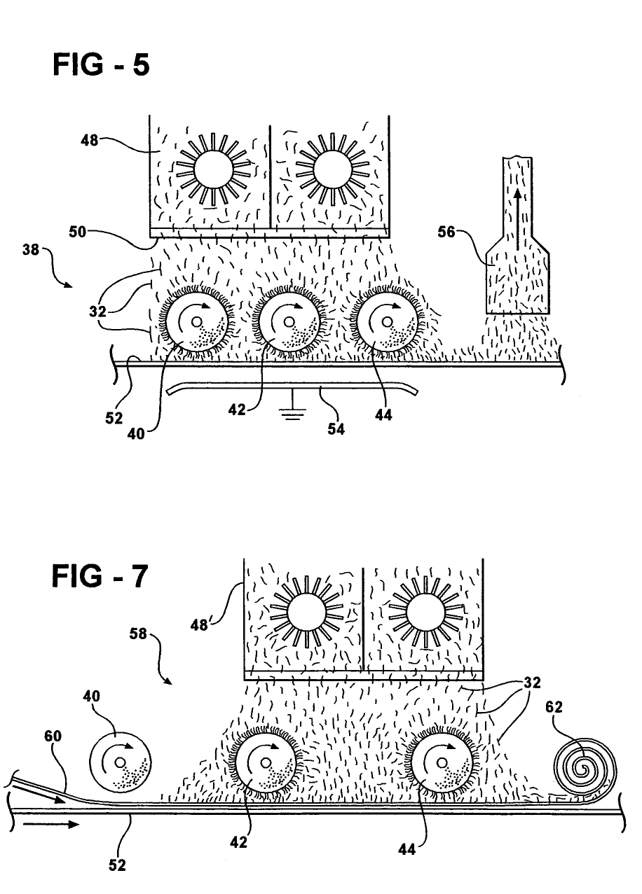

Referring now to FIG. 5, an illustration is shown generally at 38 of an electrostatic application process and by which the fibers 32 are flocked upon a plurality of foam sleeves, see at 40, 42, 44, et seq., according to one preferred application of the present invention. As is known, electrostatic flocking utilizes a field of static electricity and in order to orient the fibers and to promote a generally perpendicular alignment with respect to a coating surface of the rollers. Referencing further FIG. 6, a sample roller 40 is again illustrated and upon which is pre-applied an adhesive coating 46, this enabling the subsequent application of the flocked fibers 32.

Referring again to FIG. 5, a flock hopper is generally shown at 48 and by which the plurality of synthetic cut fibers are distributed in a generally downwardly blown manner. A positive electrode grid 50 is associated with the bottom of the hopper. The rollers 40, 42, 44, et seq., may be arranged in any desired fashion as they pass through the downwardly dispensed field of the fibers 32, but are in one variant mounted so that they are rotated in either of clockwise or counter-clockwise directions (see rotation directional arrows in FIG. 5 associated with each of the rollers).

A conveyor 52 is located, usually underneath the rollers, and by which fibers 32 adhered to the rollers are captured. A grounded electrode is illustrated at 54 and, in combination with the positive electrode grid 50 associated with the hopper, assists in creating the desired electromagnetic field for applying and adhering the fibers 32 to the rollers 40, 42, 44, et seq. In this manner the electrostatically charged fibers are evenly applied upon the foam outer surface layer of the rollers. A suction column 56, located downstream of the fiber hopper 48, removes excess flock fibers 32 not adhered to a given roller.

Referring finally to FIG. 7 is an illustration of an alternate and mechanical application process, see at 58, and by which the fibers 32 are again applied upon the exterior facing surface of the foam sleeves 40, 42, 44, et seq. A flock hopper 48′ may again be provided and by which the flock fibers 32 are mechanically dispersed downwardly. The rollers 40, 42, 44, et seq., are again arranged either upon or spaced slightly upwardly from a conveyor 52 and so are again rotated to draw and adhere thereupon the pluralities of flocked fibers 32. It is also desirous, in one application, to provide a disposable sheet 60, in relation to the conveyor 52, and so that the unused flock fibers 32: collect thereupon and are taken up by a reel 62 after flocking of the sleeves. It is also envisioned that other and additional flocking processes can be utilized and in order to effectively apply the synthetic fibers upon the exterior surfaces of the foam sleeves or cylinders.

Additional preferred embodiments will become apparent to those skilled in the art to which the invention pertains, without deviating from the scope of the appended claims.

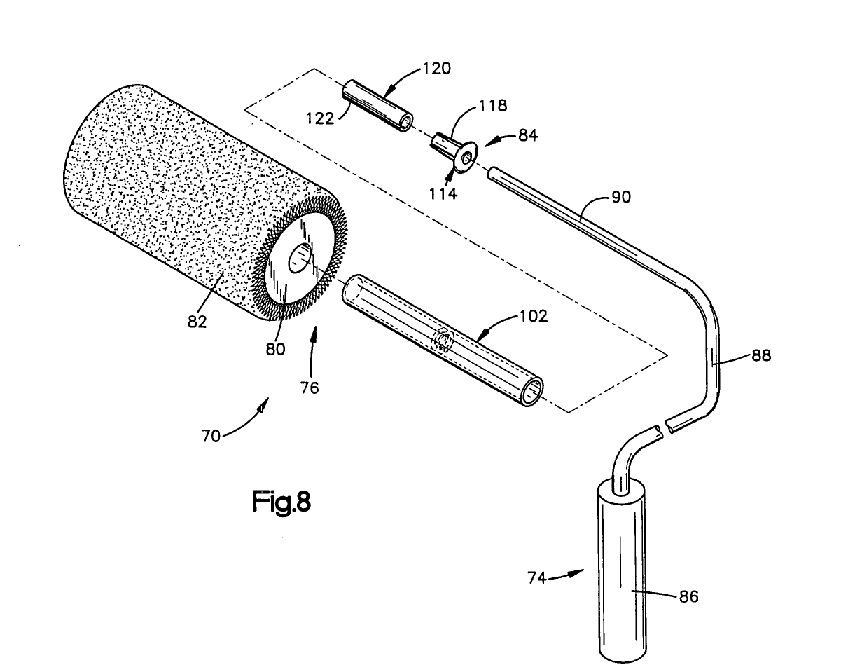

FIGS. 8-10 illustrate rollers 70 and 72 in accordance with another embodiment of the invention. The rollers 70 and 72 are generally similar to each other in construction, but differ in length, and as a result have some structural differences also. The roller 70 is nominally a four inch (length) roller, and the roller 72 is nominally a nine-inch (length) roller.

The roller 70 includes a roller handle 74 and a roller cover 76. The roller cover 76 includes a foam substrate 80, a flocked covering 82, and a plastic insert 84 that serves as a bearing for supporting the roller cover for rotation on the roller handle 74.

The roller handle 74 includes a manually graspable handle portion 86 and a metal support 88. The support 88 has a laterally extending rod 90 for supporting the roller cover 76. The rod 90 has a cylindrical configuration and is preferably about 6 millimeters in diameter.

The foam substrate 80 of the roller cover 76 is made from a material that has the capability to absorb and thereafter release the selected liquid in a sufficiently thick layer. Specifically, the foam substrate 80 has to be thick enough to absorb a sufficient amount of material to make a suitable application to the wall surface being coated.

The foam substrate 80 in the four inch roller 70 is about 4 inches long and about 2.0 to about 2.25 inches in diameter. This size is adapted to simulate a more standard sized paint roller. No such standard sized paint roller on the market is suitable for application of the particular materials for which applicant's roller is used.

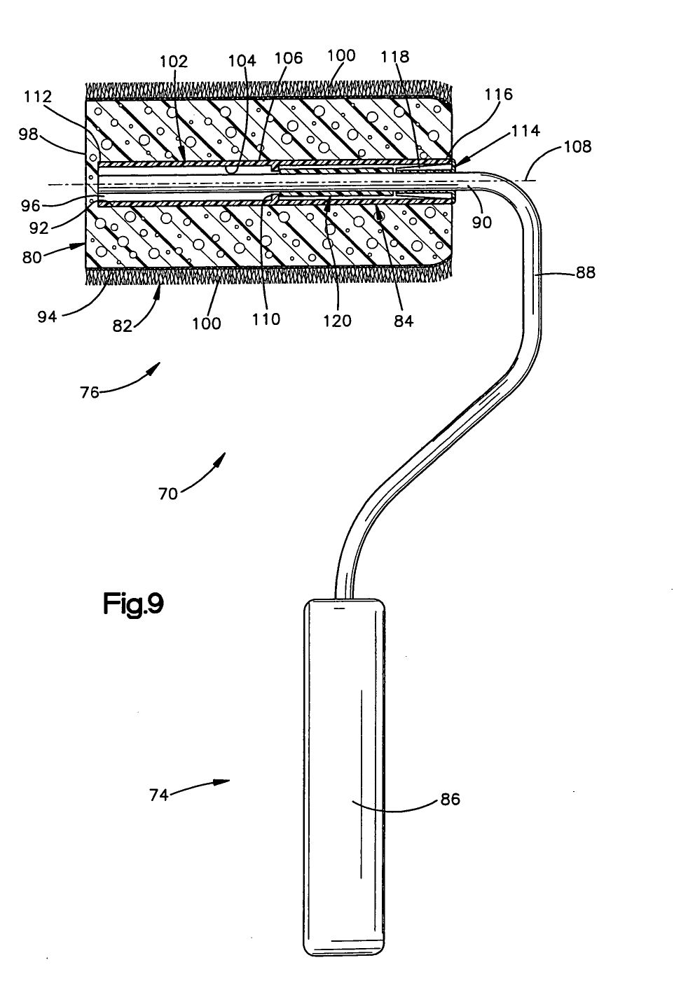

The foam substrate 80 (FIG. 9) has a generally cylindrical configuration with parallel, cylindrical inner and outer side surfaces 92 and 94. The inner surface 92 defines a central opening 96 of the substrate 80 that in the illustrated embodiment is about one half inch in diameter. The central opening 96 extends for substantially all the length of the roller cover 76 except for a thin end wall 98 that closes one end of the opening. When the roller 70 is assembled, the central opening 96 of the substrate 80 receives the bearing 84, which is glued to or otherwise adhered in the substrate.

The foam substrate 80 is cut in a solid cylinder of its finished length. The foam cylinders are cut from sheets of foam having a thickness equal to the finished length of the cylinder 80. Then the central opening 96 is punched so that the central opening extends for substantially all the length of the roller cover 76 except for the end wall 98.

The four inch roller 70 includes a foam cylinder 80 that is 4 inches long. It is difficult to cut foam of that thickness in a precise enough cylinder to provide a true enough outer surface for applying an even coat of material to the wall. More than one vendor turned down applicant as being unable to cut this type of piece, before applicant found a willing vendor. Special molds, cutting dies, etc. had to be developed to achieve this.

The foam substrate 80 as thus formed with the central opening 96 has the configuration of an annular layer of foam having a radial thickness of about seven eighths of an inch. Applicant has determined through extensive testing that a thickness in this range is adapted for and most suitable for application of a thick, pasty liquid such as a wallpaper remover or wallpaper paste.

A great deal of work was needed to determine what was the best foam for this use—thickness, pore size, pore density, etc. For example, if the pores are more open, the roller cover 76 holds more material, but with a thick foam layer the roller cover will collapse and/or won't roll. If the pores are more closed, the tendency of the roller cover to collapse is reduced but the roller cover might not absorb so much material. The foam 80 preferably has relatively large pores, to absorb the thick, viscous liquid being applied by the roller cover 76. Another factor affecting the roller characteristics is the porosity of the foam 80. A relatively large number of pores per inch is preferred.

The preferred material is a polyurethane foam (polyester based). The preferred material preferably has a net density or weight in the range of between 50 and 60 kilograms per cubic meter, preferably about 52 to 58 kilograms per cubic meter. The preferred material preferably has a pore density in the range of between 70 and 90 pores per inch, preferably about 75 pores per inch.

The preferred material also has CLD of between 5.0 and 9.0 kPa; tensile strength of 150 kPa; and elongation at break of 100 Prozent. One suitable material is Regilen 5565, available from Reisgies Schaumstoffe GmbH, Dieselstrasse 7, 51381 Leverkusen, Germany.

Because the foam substrate 80 is so thick (2.25 inches outer diameter) to hold extra material being applied, and so long (9 inches), with relatively large pore sizes and numbers of pores, it is hard to support. The bearing 84 (described below in detail) is thus specially designed to support the foam substrate 80.

As to the flocked covering 82, the selection of the flocking material is important in making a roller cover 76 that has the capability to apply the selected materials in a sufficiently thick layer. The flocked covering 82 comprises a plurality of flocking fibers 100 applied to the foam substrate 80 by one of the processes described above.

The preferred material for the flocking fibers 100 is 180 thousandths cut, 18-denier nylon 6,6. This material is also known as “180-18 semidull nylon DC” and is available from Cellusuede Products, Inc. 500 N. Madison Street, P.O. Box 716, Rockford, Ill., having a Web site at www.cellusuede.com.

The diameter and length of the fibers 100 affect the apparent softness of the flocked covering 82. Specifically, a shorter fiber 100 feels more bristly while a longer fiber is softer. The denier rating also affects softness and the ability to apply the desired liquid or semi-liquid materials. (Denier is a measure of the fineness of a yarn. For example, 9000 meters of a 15-denier yarn weighs 15 grams, and a 15-denier yarn is finer than a 30-denier yarn.) After extensive testing applicant has found that the preferred denier rating for the flocking fibers 100 is 18 denier.

The preferred length for the flocking fibers 100 is in the range of from about 4 millimeters to about 5 millimeters, and most preferably about 4.5 millimeters. This length applies a thicker coating than ordinary textile, foam or small flock paint rollers. The length of the fibers 100 determines the amount of liquid left on a surface when it is rolled. The shorter the fiber 100, the thinner the coating; the longer the fiber, the thicker the coating.

The preferred fiber 100 is also tri-lobal. That is, the yarn 100 is not circular in cross-sectional configuration, but instead has a cross-sectional configuration somewhat like a three-leaf clover. This configuration of the fiber 100 helps in retaining more material on the fibers prior to its application to the wall surface.

The bearing 84 mounts the roller cover 76 on the handle 74 for rotation relative to the handle, provides support for the roller cover along its length, and enables relatively easy removal and assembly of the roller cover even though it is firmly held on while assembled. For the four inch roller 70, the bearing 84 has two parts, a sleeve 102 and a clamp 120.

The sleeve 102 is the part of the bearing 84 to which the foam substrate 80 is adhered. The sleeve 102 is a one-piece molding having a generally cylindrical cross-sectional configuration with parallel, cylindrical inner and outer side surfaces 104 and 106 that extend parallel to a longitudinal central axis 108 of the sleeve. The sleeve axis 108 becomes the axis of the roller cover 76 as a whole.

The outer side surface 106 of the sleeve 102 is the surface to which the foam substrate 80 is adhered, preferably with a layer of adhesive. The inner side surface 104 of the sleeve 102 has a diameter that is larger than the diameter of the rod 90 of the roller handle 74. As a result, the sleeve 102 is itself rotatable freely on the rod 90.

At one location along the length of the sleeve 102, there is a very short ridge 110 that sticks radially inward from the inner surface 104 of the sleeve. This ridge 110 has an inner diameter that is still larger than the outer diameter of the rod 90. Therefore, although the rod 90 can still move freely in the sleeve 102, this ridge 110 can help to support the sleeve (and therefore help to support the form substrate 80.

One end 112 of the sleeve 102 is open for abutting against the end wall 98 of the foam substrate 80. A hollow end plug 114 plugs into the other end 116 of the sleeve 102. The end plug 114 has ribs 118 (FIG. 8) on its outside that engage firmly on the inner surface 104 of the sleeve 102, to hold the end plug securely in place in the sleeve. The inner diameter of the end plug 114 is selected so that the rod 90 can slip freely through the end plug.

The clamp 120 in the illustrated embodiment is configured as a split sleeve. But a clamp could have a different configuration. The clamp 120 has a generally cylindrical configuration with a longitudinal slot 122 so that the clamp is expandable radially outward to a larger diameter than in its free state. The diameter of the clamp 120 is selected so that when the clamp is unexpanded, it is movable freely in the sleeve 102. The diameter of the clamp 120 is selected so that when the rod 90 is pushed into and through the clamp, the clamp expands radially outward to accommodate the rod. The clamp 120 clamps tightly on the rod 90 when this occurs.

The clamp 120 is captured axially between the end plug 114 and the ridge 110. The clamp 120 does have some axial freedom of movement, but can not move out of the sleeve 102.

When the roller cover 76 is assembled to the handle 74 in this manner, the clamp 120 is clamped onto the metal rod 90. It is the only piece that is fixed to the rod 90. However, the clamp 120 even when expanded is still a little smaller in outer diameter than the inner diameter of the sleeve 102. As a result, the sleeve 102 can rotate on the clamp 120 (and, therefore, the sleeve rotates relative to the rod 90). The sleeve 102 cannot come off the metal rod 90 because of the presence of the clamp 120. As a result, the roller cover 76 is rotatable on the rod 90; the roller cover cannot come off the rod without firmly pulling; and the roller cover is supported along the length of the sleeve 102.

To change roller covers 76, the user simply pulls the roller cover axially off the rod 90, with sufficient force to have the clamp 120 slide along the rod. The user then inserts the rod 90 into a new roller cover 76.

The bearing 84 allows the roller cover 76 to roll easily. If the roller cover 76 itself were supported directly on the roller handle shaft 90, tightly enough to provide the needed stability and support, the rolling resistance would be significantly higher. Providing a built in bearing 84 that is designed specifically for low rolling resistance eliminates this problem.

In addition, the foam substrate 80 is supported along its entire length by the sleeve 102. This feature enables the use of a more porous foam 80. A more porous foam 80 is better suited to absorbing and holding the larger quantities of the more viscous (thicker) liquids for which the roller 70 is intended. The foam 80 has to be strong enough not to collapse when pressure is applied to it, so it will roll easily and apply an even layer of material. The more porous foam 80 is softer and more likely to collapse, especially in the relatively thick configuration illustrated, and so supporting it along its entire length as with the sleeve 102 enables the user to obtain the advantages of the increased porosity without any collapsing upon the application of force such as occurs when the roller 70 is applied to a wall surface. The combination of the selected flocking material 82 and its configuration, the selected foam material 80 and its configuration, and the bearing 84, provides a roller cover 76 that rolls easily under pressure without collapsing while applying a thick material in sufficient amounts.

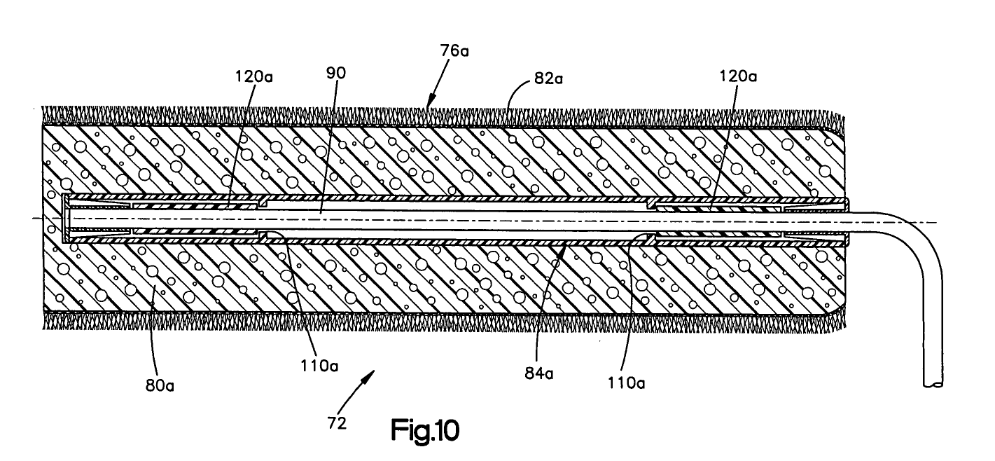

The present invention is also embodied in the 9 inch (length) roller 72 that is shown in FIG. 10. The foam substrate 80a in the nine inch roller is about 8.75 inches long, and about 2.25 inches in diameter.

The bearing assembly 84a in the four inch roller is somewhat different from the bearing assembly 80 in the 9 inch roller, because the roller cover 76a is longer. Specifically, the clamp 120a includes two split sleeves, not just one. An additional difference is that the sleeve 102a includes two internal ridges 110a. Because the clamp 120a includes two split sleeves, which are spaced apart along the length of the sleeve 102, the roller cover 76a is supported at spaced locations along its length. As a result, the roller cover 76a is more stable, and any tendency to wobbling is minimized.

From the above description of the invention, those skilled in the art will perceive improvements, changes, and modifications in the invention. Such improvements, changes, and modifications within the skill of the art are intended to be included within the scope of the invention.

1. A roller cover for application of liquids or pastes such as wallcovering adhesive and stripper, said roller cover for use with a roller handle including a shaft on which said roller cover is supported for rotation, said roller cover comprising:
a foam substrate having an inner peripheral surface and an outer peripheral surface;
a bearing to which said inner peripheral surface of said foam substrate is secured; and
a flocked covering on said outer peripheral surface of said foam substrate;
said bearing having a longitudinal central opening for receiving the shaft of the roller handle;
said bearing including a first portion to which said foam substrate is secured and a second portion for clamping the shaft of the roller handle when the bearing receives the shaft, said second portion of said bearing being rotatable within said first portion of said bearing to support said roller cover for rotation about said second portion of said bearing and thereby about the shaft of the roller handle when the bearing receives the shaft.

2. A roller cover as set forth in claim 1 wherein said first portion of said bearing extends for substantially the entire length of said foam substrate and includes a part for controlling movement of said second portion of said bearing longitudinally relative to and within said first portion of said bearing.

3. A roller cover as set forth in claim 1 wherein said second portion of said bearing includes at least one clamp.

4. A roller cover as set forth in claim 1 wherein said second portion of said bearing includes at least two clamps.

5. A roller cover as set forth in claim 1 wherein said second portion of said bearing includes one or more split sleeves into which the shaft of the roller handle can be pushed to clamp onto the shaft of the roller handle.

6. A roller cover as set forth in claim 6 wherein:
said first portion of said bearing has an inner diameter; and
each one of said split sleeves has an outer diameter that is less than the inner diameter of said first portion of said bearing when said split sleeves are in a free state and when said split sleeves receive the shaft of the roller handle.

7. A roller cover as set forth in claim 1 wherein said foam substrate has a cylindrical configuration with a radial thickness in the range of from about one half inch to about one inch and a length in the range of from about 4 inches to about nine inches.

8. A roller cover as set forth in claim 1 wherein said flocked covering comprises a plurality of flocking fibers that are 18-denier nylon and that have a length in the range of from about 4 millimeters to about 5 millimeters.

9. A roller cover as set forth in claim 8 wherein said flocked covering comprises a plurality of flocking fibers that are 18-denier nylon and that have a length in the range of from about 4 millimeters to about 5 millimeters.

10. A roller cover for application of liquids or pastes such as wallcovering adhesive and stripper, said roller cover for use with a roller handle including a shaft on which said roller cover is supported for rotation, said roller cover comprising:
a foam substrate having an inner peripheral surface and an outer peripheral surface;
a bearing to which said inner peripheral surface of said foam cylinder is secured; and
a flocked covering on said outer peripheral surface of said foam substrate;
said bearing having a longitudinal central opening for receiving the shaft of the roller handle;
said foam substrate having a cylindrical configuration with a radial thickness in the range of from about one half inch to about one inch.

11. A roller cover as set forth in claim 10 wherein said foam substrate has a cylindrical configuration with a radial thickness of about three quarters to seven eighths of an inch.

12. A roller cover as set forth in claim 10 wherein said foam substrate has a cylindrical configuration with a length of eight and one half inches to about nine inches.

13. roller cover as set forth in claim 10 wherein said foam substrate has a cylindrical configuration with a length of about four inches.

14. A roller cover as set forth in claim 10 wherein said foam substrate is a polyurethane foam with a net density or weight in the range of between 50 and 60 kilograms per cubic meter, and a pore density in the range of between 70 and 90 pores per inch.

15. A roller cover as set forth in claim 14 wherein said foam substrate has a net density or weight in the range of from 52 to 58 kilograms per cubic meter, and a pore density of about 75 pores per inch.

16. A roller cover as set forth in claim 10 wherein said flocked covering comprises a plurality of flocking fibers that are selected for the capability to apply viscous and/or paste-like materials in a thick layer.

17. A roller cover as set forth in claim 10 wherein said flocked covering comprises a plurality of flocking fibers that are 180 thousandths cut, 18-denier nylon 6,6.

18. A roller cover as set forth in claim 10 wherein said flocked covering comprises a plurality of flocking fibers that have a length in the range of from about 4 millimeters to about 5 millimeters.

19. A roller cover as set forth in claim 10 wherein said flocked covering comprises a plurality of flocking fibers that have a length of about 4.5 millimeters.

20. A roller cover as set forth in claim 10 wherein said flocked covering comprises a plurality of flocking fibers that are tri-lobal.

21. A roller cover as set forth in claim 10 wherein said foam substrate has a cylindrical configuration with a radial thickness of about three quarters to seven eighths of an inch, and said flocked covering comprises a plurality of flocking fibers that have a length in the range of from about 4 millimeters to about 5 millimeters.

22. A roller cover as set forth in claim 21 wherein said bearing includes a first portion to which said foam substrate is secured and a second portion for clamping the shaft of the roller handle when the bearing receives the shaft, said second portion of said bearing being rotatable within said first portion of said bearing to support said roller cover for rotation about said second portion of said bearing and thereby about the shaft of the roller handle when the bearing receives the shaft.

23. A roller cover as set forth in claim 22 wherein said second portion of said bearing comprises at least one split sleeve.
